(19) United States
(12) Patent Application Publication
(10) Pub. No.: US 2006/0184553 A1
(43) Pub. Date: Aug. 17, 2006

(54) Distributed MPEG-7 based surveillance servers for digital surveillance applications

(75) Inventors: Lipin Liu, Belle Mead, NJ (US); K.C. Lee, Princeton, NJ (US); Hasan Timucin Ozdemir, Plainsboro, NJ (US)

Correspondence Address: HARNESS, DICKEY & PIERCE, P.L.C., P.O. BOX 828, BLOOMFIELD HILLS, MI, 48303, US

(73) Assignee: Matsushita Electric Industrial Co., Ltd., Osaka (JP)

(21) Appl. No.: 11/058,524

(22) Filed: Feb. 15, 2005

(51) Int. Cl. G06F 17/00

(52) U.S. Cl. 707/101

(57) ABSTRACT

Distributed MPEG-7 based Surveillance Servers for Digital Surveillance Applications (DM7SS), provides a distributed MPEG-7 compliant surveillance system platform that can provide flexible and extensible indexing and searching mechanisms based on MPEG-7 standards and technologies for distributed digital surveillance systems. A database manager implements a database process to manage metadata and predefined descriptors of surveillance video clips by sending the metadata to a database engine that handles storage of data into and retrieval of data from a relational database management system, and mapping or converting the predefined descriptors into schema of a relational database. A search manager handles an archive video search process, wherein a master server provides unified interfaces for video search requests that can be processed concurrently among slave servers. An update manager allows new modules to be added to a server, such as new description schema definitions, new metadata processing procedures, and new search processing procedures.

### FIELD OF THE INVENTION

The present invention generally relates to digital surveillance systems, and relates in particular to a distributed surveillance server platform system for digital surveillance applications.

### BACKGROUND AND SUMMARY OF THE INVENTION

A digital surveillance system can be used in variety application domains, and have different needs relating video content storage and retrieval. Surveillance applications usually generate a large amount of video (media) resources, store in the recorder or long-term storage system, and search and retrieve them when needed. For large-scale surveillance systems, used in the airport, highway, river monitoring, etc., which have hundreds of cameras and many distributed recorders, complexity is increased not only in live monitoring, but also in search and retrieval of recorded media clips.

Problems of existing search and retrieval mechanism in digital surveillance systems are numerous. For example, search provides only one or very few search keys such as camera, date/time, and event. Also, there are difficulties in search and retrieval handling for large-scale surveillance systems. Further, there is no description or information regarding actual content of recorded media. Yet further, there is no flexibility for extending the search indexing. Further still, such systems are not compliant to today's standards.

An ideal digital surveillance system shall provide an efficient search and retrieval function and flexible indexing methods that facilitate fast location and retrieval of archived video clips. The present invention, referred to herein as Distributed MPEG-7 based Surveillance Servers for Digital Surveillance Applications (DM7SS), provides a distributed MPEG-7 compliant surveillance system platform that can provide flexible and extensible indexing and searching mechanisms based on MPEG-7 standards and technologies for distributed digital surveillance systems.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is an entity relationship diagram illustrating a DM7SS system configuration in accordance with the present invention;

FIG. 2 is a functional block diagram illustrating a system architecture for a DM7SS digital surveillance system in accordance with the present invention, including an architecture overview in FIG. 2A, and architecture component details in FIGS. 2B-2D;

FIG. 3 is a functional block diagram illustrating an MPEG-7 master/slave server architecture in accordance with the present invention;

FIG. 4 is a functional block diagram illustrating an architecture of an MPEG-7 master server in accordance with the present invention;

FIG. 5 is a functional block diagram illustrating an architecture of an MPEG-7 server in accordance with the present invention;

FIG. 6 is a block diagram illustrating a hierarchy of a multi-level description mechanism in an MPEG-7 surveillance server in accordance with the present invention;

FIG. 7 is a block diagram illustrating a DM7SS MPEG-7 message platform in accordance with the present invention;

FIG. 8 is a display view illustrating a DM7SS portal MPEG-7 video search GUI in accordance with the present invention;

FIG. 9 is a display view illustrating a DM7SS portal domain knowledge profile extender GUI in accordance with the present invention;

FIG. 10 is a display view of a DM7SS portal MPEG-7 annotator GUI in accordance with the present invention; and

FIG. 11 is a display view of a DM7SS portal MPEG-7 video monitor and viewer GUI in accordance with the present invention.

### DETAILED DESCRIPTION OF THE PREFERRED EMBODIMENTS

The following description of the preferred embodiments is merely exemplary in nature and is in no way intended to limit the invention, its application, or uses.

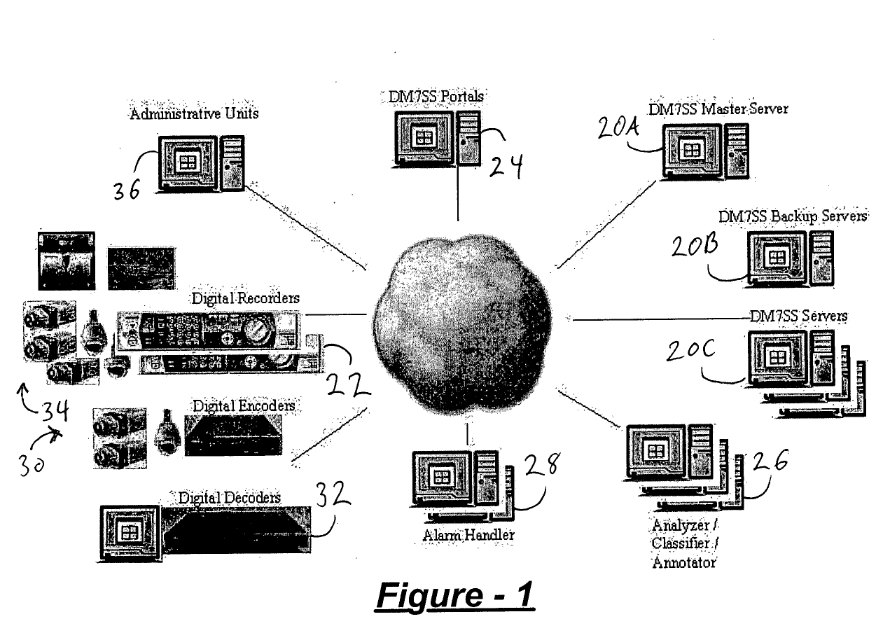

Referring to FIG. 1, an example of the DM7SS platform configuration contains distributed MPEG-7 surveillance servers 20A-20C, including master servers 20A, backup servers 20B, and slave servers 20C. IT also includes surveillance digital recorders 22, surveillance portals 24, analyzer/classifier/annotator 26, alarm handler 28, encoders 30, decoders 32, cameras 34, other administrative servers 36 such as resource management servers, and other components.

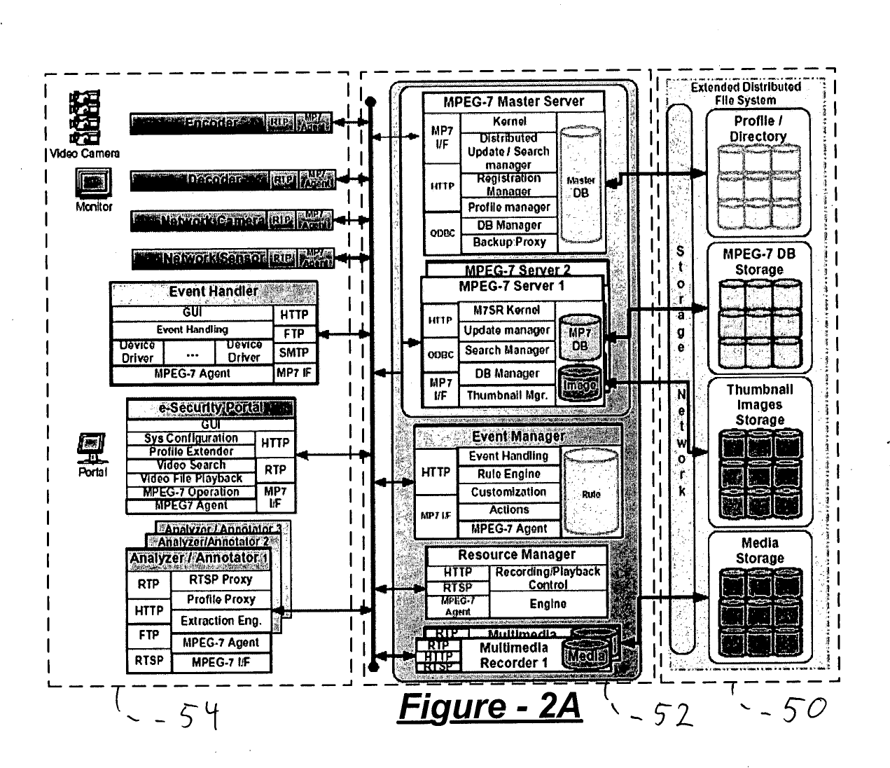

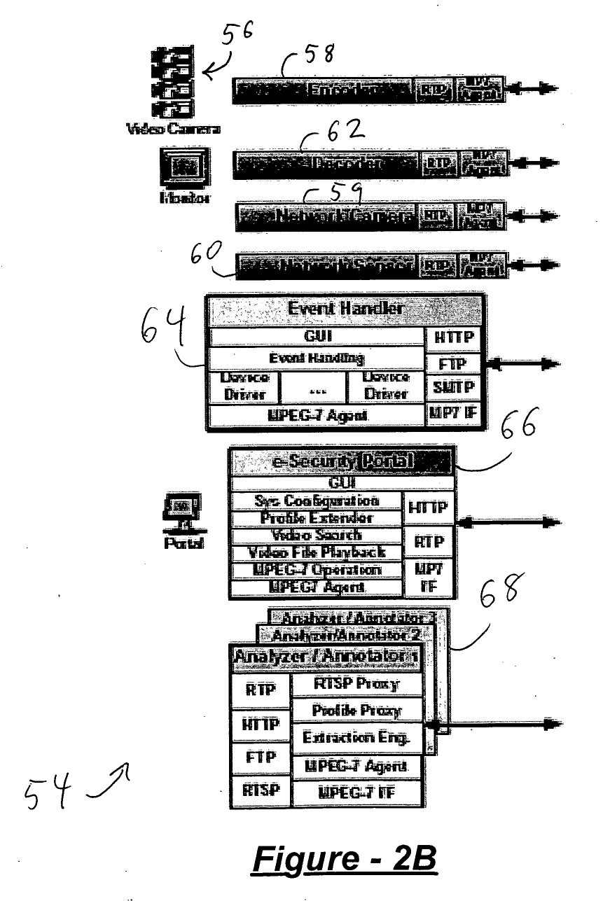

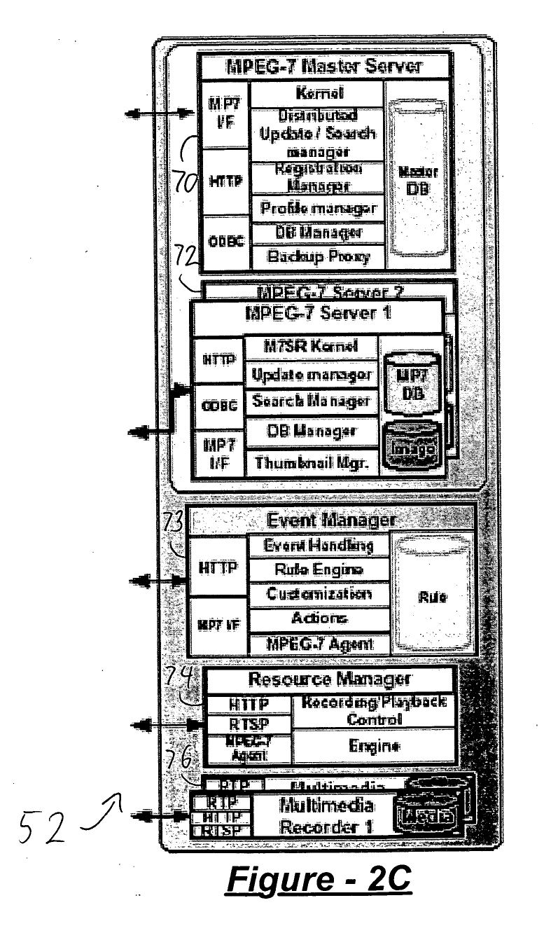

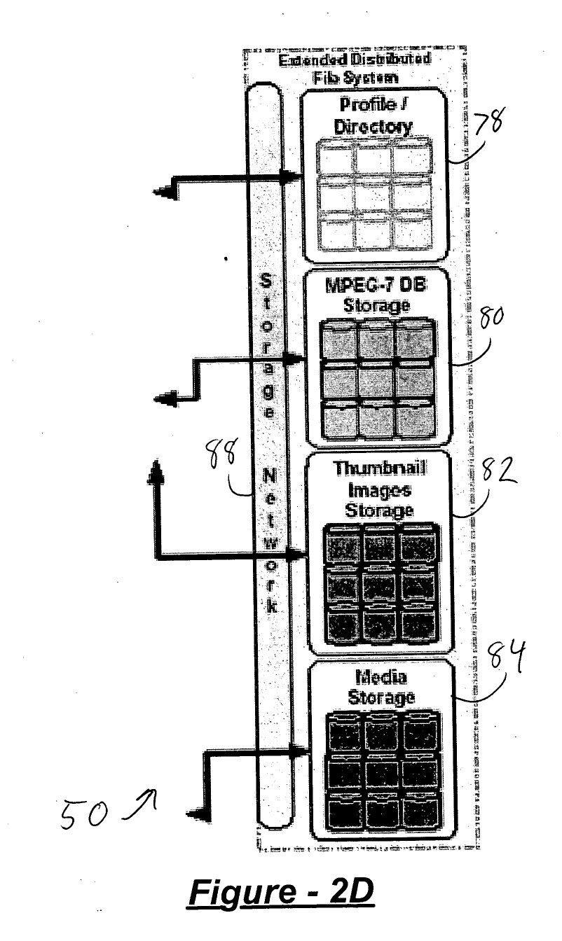

Turning now to FIG. 2A, the platform system can be organized into storage components 50, server components 52, and devices and services 54. Turning to FIG. 2B, for example, devices and services 54 can include video cameras 56, network cameras 59, encoders 58, sensors/alarm handlers 60, hardware decoders 62, event handler 64, e-security portals 66, and media analyzers/annotators 68. Also, turning to FIG. 2C, server components 52 can include master servers 70, slave servers 72, event manager 73, resource managers 74, and multimedia recorders 76. Further, turning to FIG. 2D, storage components 50 can include profile and directory storage 78, MPEG-7 database storage 80, thumbnail images storage 82, and media storage 84 of a storage network 88, thus forming an extended, distributed file system.

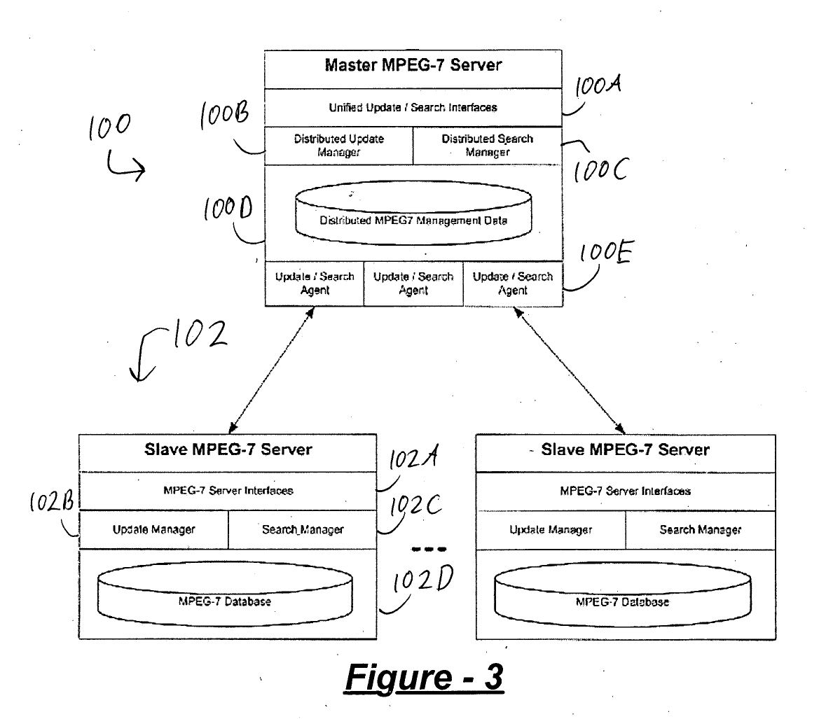

Turning now to FIG. 3, there are three types of MPEG-7 surveillance servers: (a) MPEG-7 master server 100; (b) MPEG-7 slave server 102 (also referred to herein as MPEG-7 server); and (c) MPEG-7 backup server (not shown). To consider scalability for MPEG-7 server, the system allows multiple MPEG-7 servers in the distributed system. Within the system, there is only one master MPEG-7 server 100, but the system can have multiple slave MPEG-7 servers 102 work with one master server 100. Backup server is used as a backup of master server 100. If anything is wrong on the MPEG-7 master server 100, backup server can take control and become a master server immediately. Backup server has real-time backup (mirror) data of master server 100. Components of MPEG-7 slave server 102 include MPEG-7 server interfaces 102A, update manager 102B, search manager 102C, and MPEG-7 database 102D. Components of MPEG-7 master server 100 include unified update/search interfaces 100A, distributed update manager 100B, distributed search manager 100C, distributed MPEG-7 management data 100D, and update/search agents 100E.

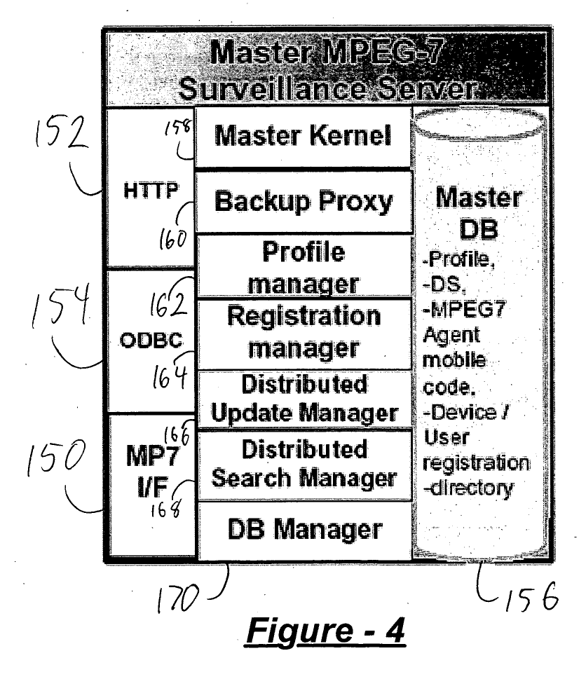

Turning now to FIG. 4, MPEG-7 master server provides the management function of distributed MPEG-7 slave servers, analyzers, alarm handlers, and annotators. It also maintains the definition of alarm settings, MPEG-7 descriptors, extended modules, and profiles. The master server also fulfills event summary view of all recorded contents among distributed MPEG-7 servers. Modules of MPEG-7 master server include MPEG-7 interfaces 150, HTTP server 152, ODBC adaptor 154, master MPEG-7 database 156, master kernel 158, backup proxy 160, profile/extender/alarm definition manager 162, analyzer/alarm handler registration manager 164, distributed update manager 166, distributed search manager 168, and database manager 170.

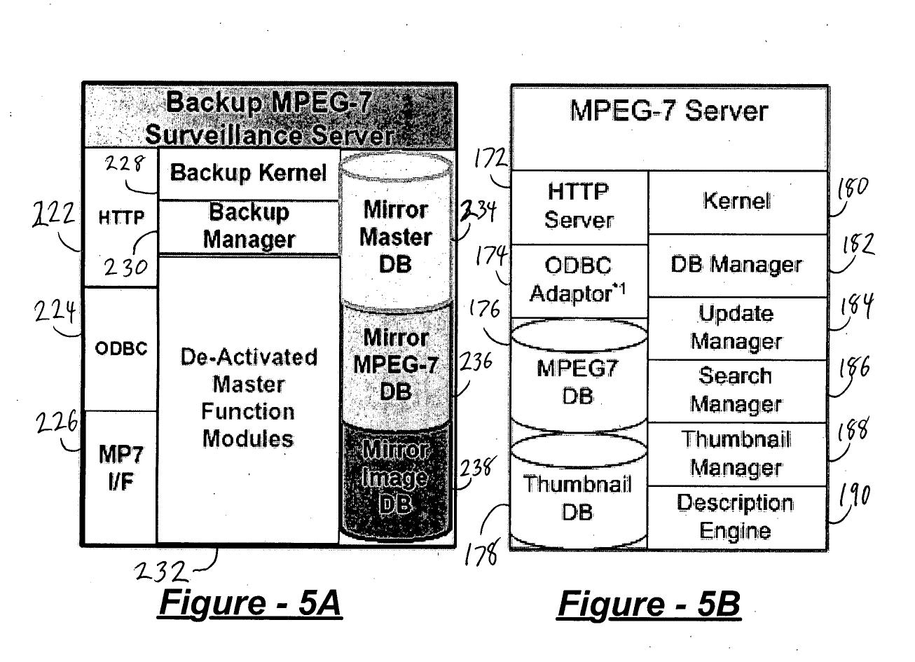

Turning to FIG. 5A, MPEG-7 backup server provides real time back up features and can be switched to MPEG-7 Master server immediately when master server fails. Modules of MPEG-7 backup server include HTTP server 222, ODBC adaptor 224, MPEG-7 Interface 226, backup kernel 228, backup manager 230, master server function modules in de-activated mode 232, mirror master database 234, mirror MPEG-7 DB 236, and mirror image DB 238.

Referring to FIG. 5B, MPEG-7 slave server provides fundamental MPEG-7 functions such as update and search. Modules of MPEG-7 slave server include HTTP server 172, ODBC adaptor 174, MPEG-7 database 176, thumbnail database 178, kernel 180, database manager 182, update manager 184, search manager 186, thumbnail manager 188, and description engine 190.

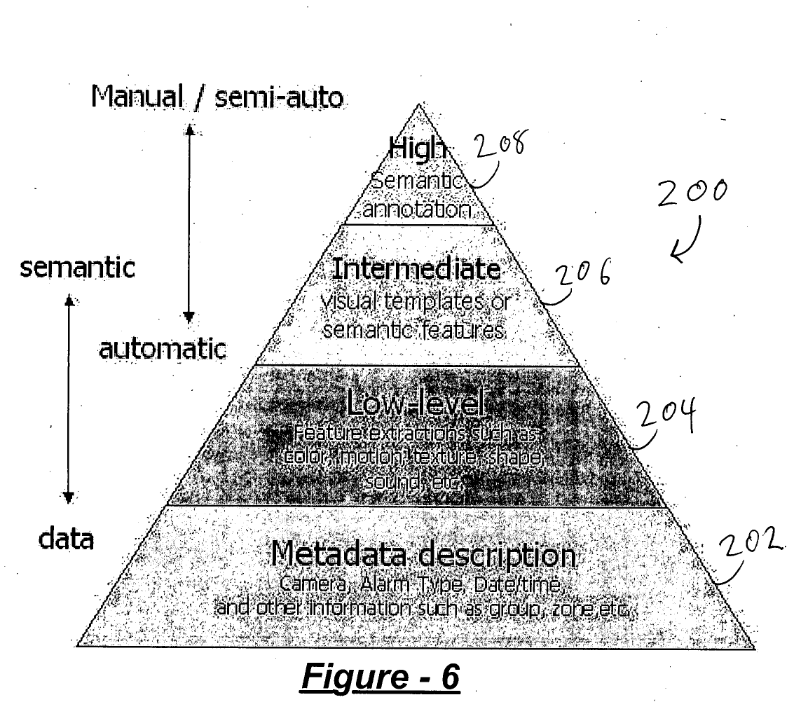

Turning now to FIG. 6, some embodiments of the present invention employ a hierarchical MPEG-7 server data model 200. Accordingly, there are several levels of description data within MPEG-7 surveillance server systems, including (a) metadata level data 202 indicating camera, alarm type, date/time, and other information such as group, zone, etc.; (b) low-level description data 204 indicating feature extractions such as color, motion, texture, shape, sound, etc.; (c) intermediate level description data 206 indicating visual templates or semantic features; and (d) high-level description data 208 indicating semantic annotation. Relatively higher level data tends to be more manually or semi-automatically generated than comparatively lower level, which tends to be more automatically generated. Also, lower level data tends to be more like raw data, whereas comparatively higher level data tends to be more semantic in nature. The media analyzer according to the present invention usually generates lower level data from feature extraction. A classifier according to the present invention can take lower level data stored in a MPEG-7 DB server and classify the lower level data into higher level data such as objects and/or semantic events. An annotator according to the present invention can be used by a human user to generate semantic description data and metadata.

MPEG-7 servers manage and store these description data with indexes for fast retrieval in a relational database system. The tables of the database can include the following categories: (a) metadata of recorded video content, event, alarm setting, thumbnail, etc.; (b) MPEG-7 description for recorded video contents or analyzed video contents; (c) description indexes for fast search based on descriptors; and (d) MPEG-7 servers related configuration and equipment setting data in the master server.

Metadata stored in MPEG-7 servers are fundamental media information of recorded video, event information, alarm setting and status, thumbnail information and image storage, and equipment configuration. These metadata are stored in the several tables of the relational database, and they are fundamental data for a digital surveillance system. The metadata tables can also serve as media description indexes for faster search operations.

MPEG-7 surveillance servers store MPEG-7 based descriptions for all the recorded video contents. The descriptions can help to identify target video clips much faster than browse all video clips manually. The descriptions used in the system can include: (a) one description for each incidence of media content, containing the segment description links and/or actual media segment description contents; (b) one description for each media segment; (c) multi-level descriptions: (i) high-level (semantic based) descriptors; (ii) intermediate-level (objects) descriptors; and (iii) low-level descriptors (e.g. MPEG-7 visual descriptor); (d) a set of high-level descriptors derived from existing MPEG-7 standard description types; and (e) DM7SS analyzing services (analyzer, classifier, and annotator) that classify, process, and/or use similarity matching to map or transform low-level descriptions into higher descriptions.

Turning now to FIG. 7, the DM7SS surveillance system compliant to MPEG-7 standards applies MPEG-7 to its communication message platform 250. MPEG-7 based messages 252A-252H are used for the purposes of content description, indexing, searching and retrieval. The system has a MPEG-7 message platform for all the devices to exchange MPEG-7 descriptions. These devices can include event manager 254, resource manager 256, multimedia recorders 258, MPEG-7 servers 160, encoders 262, network cameras/sensors 264, media analyzers 266, and event handlers 268. These devices employ MPEG-7 agents 270A-270H to exchange the descriptions. This message platform is compatible to be expanded to MPEG-21 in the future.

It is preferred that devices in the surveillance system, including cameras or encoders, sensors or alarm handlers, analyzers, and etc., are DM7SS message compliant and have the capability to produce MPEG-7 description messages. For instance, a camera can detect motion and produce MPEG-7 descriptions. These MPEG-7 description messages can be sent to alarm handlers or MPEG-7 servers for processing or indexing. The devices can then send more intelligent data rather then raw media data. However, it is envisioned that media analyzer services can be employed by the system to analyze captured media and/or monitor the devices as they capture the media in order to generate the MPEG-7 descriptors.

One of the major functions of MPEG-7 server is to keep track of all video recording metadata and content-based indexes. With this information, MPEG-7 server can know what has been recorded, and can perform search efficiently from large amounts of archived video clips. Master MPEG-7 server handles all the incoming update requests with data, and dispatches requests to proper slave MPEG-7 servers. Table 1 contains types of update operations handled by MPEG-7 server.

TABLE 1

| Update | |
|---|---|
| Function | Description |
| Record video | Metadata of recorded video clips. |
| metadata | Camera ID, alarm types, data |
| | and time, etc. |
| Content | Descriptors as indexes for record |
| descriptors | video clips. These descriptor data |
| | are usually generated by analyzers. |
| Configuration | MPEG-7 server, equipment, alarm |
| | configuration, user, and etc. |
| Thumbnail | Key frame images of archived video |
| Images | clips generated by Analyzer. |

MPEG-7 server has a search manager to handle an archive video search process. The master MPEG-7 server provides unified interfaces for video search requests. These requests can be processed concurrently among related slave MPEG-7 servers. From a user's point of view, these distributed MPEG-7 servers become a virtual integrated MPEG-7 server. Table 2 contains search operations handled by MPEG-7 server.

TABLE 2

| Search Function | Description |
|---|---|
| Search based on video | Search recorded video |
| metadata | clips based on camera ID, |
| | alarm types, and data |
| | and time. |
| Search based on Content | Search descriptors that |
| descriptors | describe contents of |
| | record video clips. |
| Search from multiple | Search video data from |
| distributed MPEG-7 servers | multiple distributed slave |
| | MPEG-7 servers. |
| Thumbnail viewing | Retrieve thumbnail |
| | images of archived video |
| | clips. |

The database manager implements a database process that manages meta-data (the camera, date and time, sensor/alarm information and so on) and MPEG-7 descriptors of the surveillance video clips, which are recorded to MM Recorder servers. The database process sends the metadata directly to a database engine that handles storing and retrieving of all data into the relational database management system (RDBMS). For MPEG-7 descriptor data, the database process maps and/or converts the data into relational database schema via XML database middleware. Table 3 contains database operations handled by MPEG-7 server.

TABLE 3

| Database Function | Description |
|---|---|
| Metadata DB operation | Search recorded video |
| | clips based on camera ID, |
| | alarm types, and data |
| | and time. |
| MPEG-7 descriptors DB | Search descriptors that |
| operation | describe contents of record |
| | video clips. |
| Configuration data DB | Search video data from |
| operation | multiple distributed slave |
| | MPEG-7 servers. |
| Thumbnail images store | Retrieve thumbnail images |
| | of archived video clips. |

The thumbnail manager implements a process that manages MPEG-7 thumbnail images. Table 4 contains thumbnail operations handled by MPEG-7 server.

TABLE 4

| Database Function | Description |
|---|---|
| Thumbnail images storage | Retrieve thumbnail images |
| | of archived video clips. |
| Thumbnail management | Keep track of image ID |
| | (name) and physical location. |

Update manager is an extensible module manager that allows new modules to be added into MPEG-7 server. The new modules can be new MPEG-7 description schema definition using DDL, new metadata DB processing, new search processing, and so on. Table 5 contains extensible module operations handled by MPEG-7 server.

TABLE 5

| Function | Description |
|---|---|
| Extensible module | Allow adding new extensible |
| upload | modules. |
| Extensible module | Registration of extensible |
| manager | module. Delete and un-register |
| | modules. List modules. |

Profile manager manages definition of domain knowledge profiles in the MPEG-7 master server. The profile is used by all devices and MPEG-7 servers to fit the application needs. Since digital surveillance systems can be used in many different application domains, the MPEG-7 server domain knowledge profile can be adjusted in terms of sets of descriptors, sets of metadata, sets of search, sets of alarm handling, sets of functional modules, and so on. The functional modules can be extended by users with installation, and the base modules include MPEG-7 message delivery and message parsing, encoding and decoding, and metadata to description mapping and vice versa.

A profile definition can include the following profile component items: (a) profile information; (b) description schemes; (c) descriptors definition sets; (d) metadata definition sets; (e) application operation interfaces; (f) application operation modules locator; and (g) module (e.g., mobile code) storage. Table 6 contains profile management operations handled by MPEG-7 master server.

TABLE 6

| Function | Description |
|---|---|
| Profile | Registration of profiles. Delete |
| management | and un-register profiles. List |
| | current profiles. Edit profile |
| | settings. . . |
| Profile | Allow adding new profile components, |
| component | editing existing profile |
| management | component settings, and deleting |
| | profile components |
| Query and | Profile listing, active profile, |
| retrieve | profile settings, profile components, |
| | contents of profile components, |
| | and application operation |
| | module locator |
| On demand | Download application operation |
| module | module on-demand basis to |
| download | devices or application programs. |
| | For instance, video camera |
| | sensors download a MPEG-7 |
| | agent mobile code with updated |
| | operation functions for |
| | messaging delivery and metadata |
| | association mapping with |
| | description scheme definition, . |

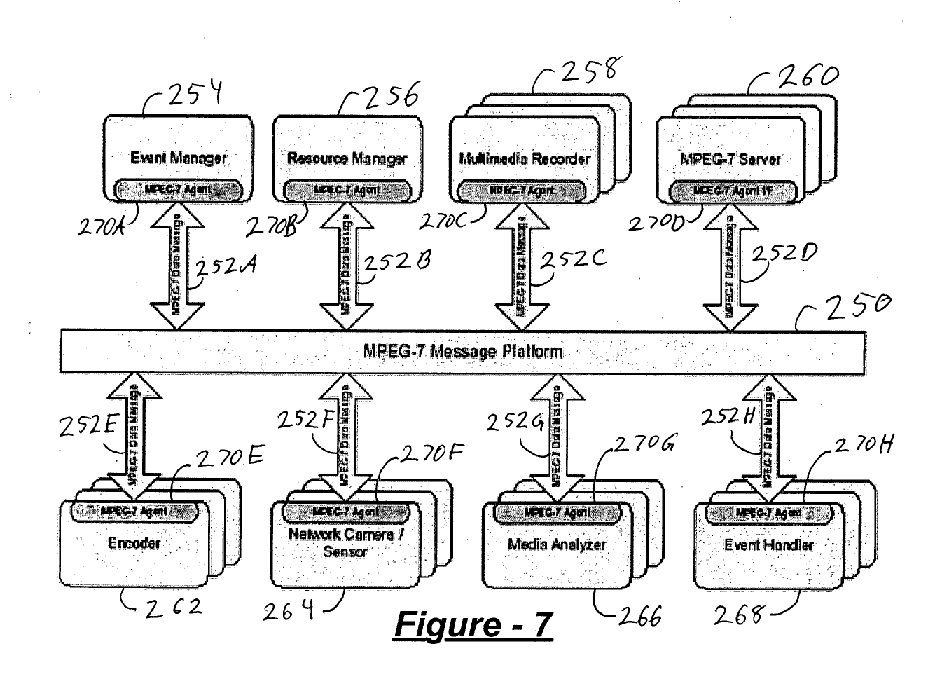

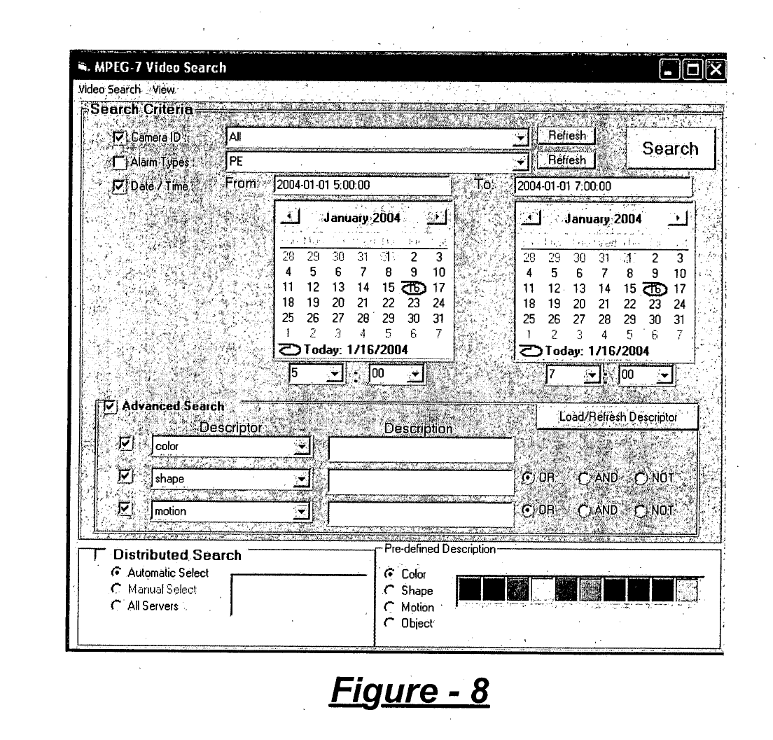

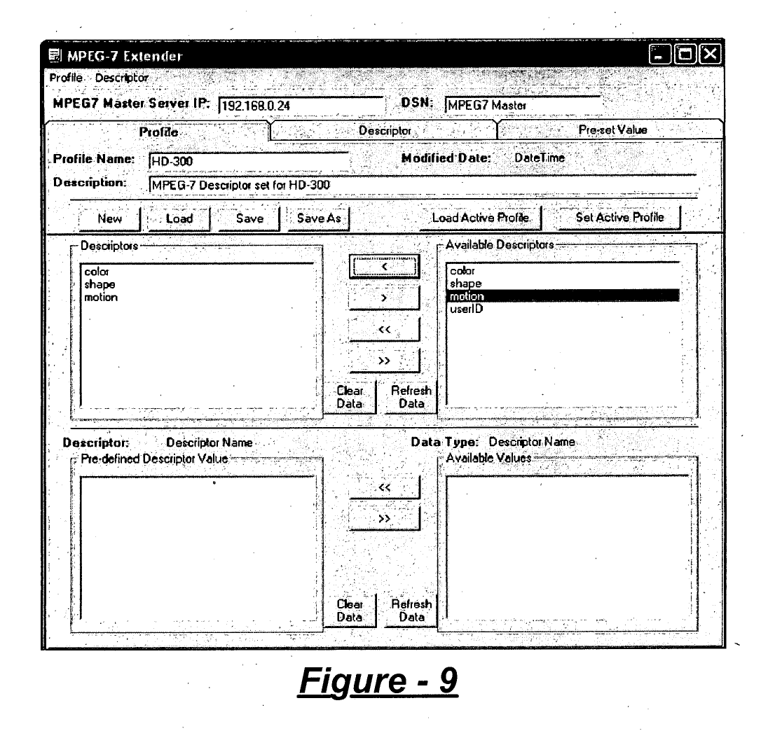

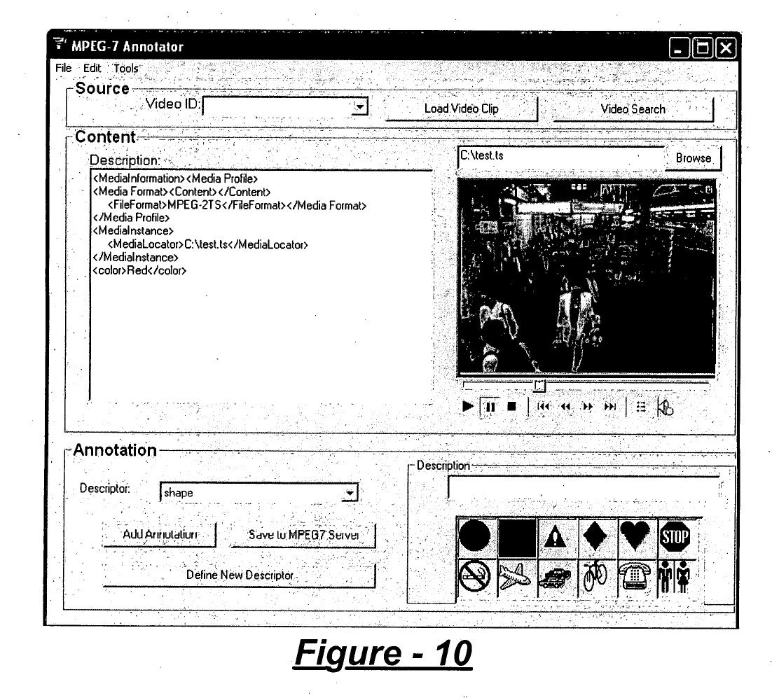

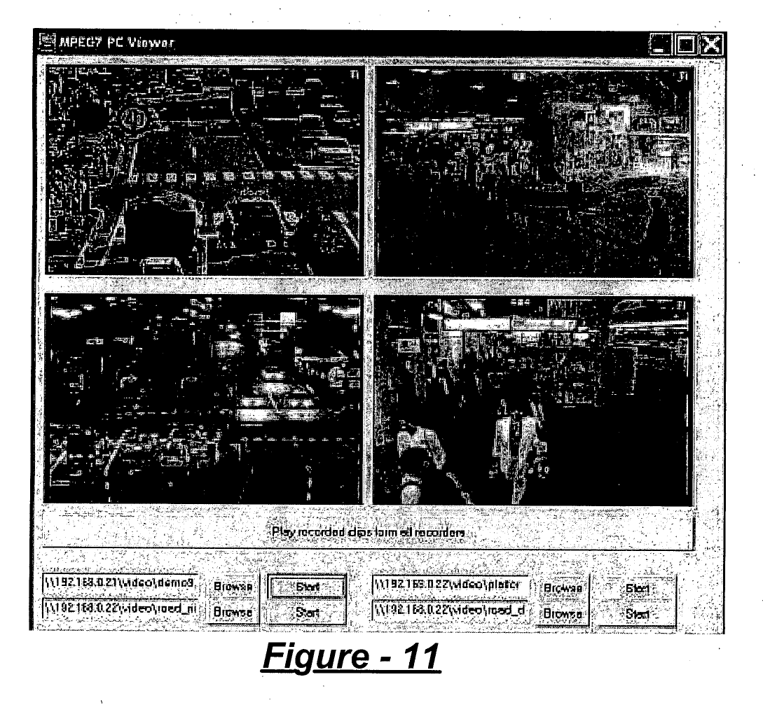

Turning finally to FIGS. 7-11, DM7SS portal provides the following features: (a) distributed surveillance video search (FIG. 8); (b) DM7SS domain knowledge profile extender (FIG. 9); DM7SS annotator (FIG. 10); (c) DM7SS operations, administration and maintenance client (not shown); and (d) DM7SS video monitor and viewer (FIG. 11). For example, the distributed surveillance video search component (FIG. 8) of the graphical user interface allows a user to search recorded video by time, alarm type, camera ID, and descriptors relating to one or more of shape, color, motion, and objects recognized in the recorded video. Also, the domain knowledge profile extender component (FIG. 9) of the graphical user interface allows a user to extend a profile by adjusting one or more descriptors sets of the profile, including descriptor names and descriptor data types. Further, the annotator component (FIG. 10) of the graphical user interface allows a user to view a hierarchical description of recorded video, and provide relatively high level descriptors for recorded video in the form of textual annotations. Further, the video monitor and viewer component (FIG. 11) of the graphical user interface allows a user to browse and view surveillance video organized according to the schema by accessing video file paths composed of the descriptors according to the schema.

As can be readily appreciated from the foregoing description, the present invention can provide several advantages for a distributed digital surveillance system. For example, the present invention provides efficient MPEG-7-based search and retrieval services among large-scale distributed digital surveillance recorder servers. The present invention also provides flexible and extensible MPEG-7 description indexing and query criteria fields mechanisms based on MPEG-7 standards and technologies for distributed digital surveillance systems. The present invention further provides easy-to-use pre-defined domain knowledge profile sets for different digital surveillance applications. Accordingly, the present invention can be used for most digital surveillance systems, and is especially advantageous when used for large-scale distributed systems that require search of recorded contents from many distributed recorder systems.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A distributed surveillance platform system, comprising:
a database manager implementing a database process that manages metadata and predefined descriptors of surveillance video clips, including: (a) sending the metadata to a database engine that handles storage of data into and retrieval of data from a relational database management system; and (b) one or more of mapping and converting the predefined descriptors into schema of a relational database; and
a search manager handling an archive video search process, wherein a master server provides unified interfaces for video search requests that can be processed concurrently among slave servers; and
an update manager allowing new modules to be added into one or more of the master server and one or more slave servers, including modules defining one or more of new description schema definitions, new metadata processing procedures, and new search processing procedures, thereby modifying one or more procedures performed by one or more of said database manager and said search manager.

2. The system of claim 1, wherein the relational database system has data structures defining the schema and including metadata of one or more of recorded video content, events, alarm settings, and thumbnails.

3. The system of claim 1, wherein the relational database system has data structures defining the schema and including descriptions for one or more of recorded video contents and analyzed video contents

4. The system of claim 1, wherein the relational database system has data structures defining the schema and including description indexes for fast search based on descriptors.

5. The system of claim 1, wherein the relational database system has data structures defining the schema and including server related configuration and equipment setting data in a master server.

6. The system of claim 1, further comprising a thumbnail manager implementing a process that manages thumbnail images.

7. The system of claim 1, further comprising a profile manager allowing definition of domain knowledge profiles in the master server, wherein the profile is used by the master server to fit needs of an application.

8. The system of claim 7, wherein a profile definition covers profile information.

9. The system of claim 7, wherein a profile definition covers description schemes.

10. The system of claim 7, wherein a profile definition covers descriptor definition sets.

11. The system of claim 7, wherein a profile definition covers metadata definition sets.

12. The system of claim 7, wherein a profile definition covers application operation interfaces.

13. The system of claim 7, wherein a profile definition covers application operation modules and their locators, including a base module MPEG-7 Agent (mobile code) which can be transmitted and executed on surveillance devices.

14. The system of claim 1, further comprising a hierarchical server data model having a plurality of levels of description data within said system, including two or more of: (a) metadata level data indicating camera, alarm type, and date/time; (b) low-level description data indicating feature extractions; (c) intermediate level description data indicating one or more of visual templates or semantic features; and (d) high-level description data indicating semantic annotation.

15. The system of claim 1, further comprising a hierarchical server data model having a plurality of levels of description data within said system, including three or more of: (a) metadata level data indicating camera, alarm type, and date/time; (b) low-level description data indicating feature extractions; (c) intermediate level description data indicating one or more of visual templates or semantic features; and (d) high-level description data indicating semantic annotation.

16. The system of claim 1, wherein descriptions used in said system include one or more description for each incidence of media content, containing one or more of segment description links and actual media segment description contents.

17. The system of claim 1, wherein descriptions used in said system include multi-level descriptions including two or more of: (a) high-level (semantic based) descriptors; (b) intermediate-level descriptors; and (c) low-level descriptors.

18. The system of claim 1, wherein descriptions used in said system include a set of high-level descriptors derived from existing MPEG-7 standard description types.

19. The system of claim 1, wherein descriptions used in said system include analyzing services that one or more of classify, process, and use similarity matching to one or more of map and transform low-level descriptions into higher descriptions.

20. The system of claim 1, further comprising a message platform whereby system components exchange MPEG-7 based messages and use the messages for content description, indexing, searching, and retrieval processes.

21. The system of claim 1, further comprising a portal providing a distributed surveillance video search component of a graphical user interface whereby a user can search recorded video by time, alarm type, camera ID, and descriptors relating to one or more of shape, color, motion, and objects recognized in the recorded video.

22. The system of claim 1, further comprising a portal providing a domain knowledge profile extender component of a graphical user interface whereby a user can extend a profile by adjusting one or more descriptors sets of the profile, including descriptor names, descriptor data types, and preset values. Profile extender can extend the application modules registered in the system by uploading and registration process, wherein the profile extender component extends application modules registered in said system by using an uploading and registration process.

23. The system of claim 1, further comprising a portal providing an annotator component of a graphical user interface whereby a user can view a hierarchical description of recorded video, and provide relatively high level descriptors for recorded video in the form of textual annotations.

24. The system of claim 1, further comprising a portal providing an operations, administration, and maintenance client component of a graphical user interface.

25. The system of claim 1, further comprising a portal providing a video monitor and viewer component of a graphical user interface whereby a user can browse and view surveillance video organized according to the schema by accessing video file paths composed of the descriptors according to the schema.
